(19) United States
(12) Patent Application Publication
(10) Pub. No.: US 2018/0321957 A1
(43) Pub. Date: Nov. 8, 2018

(54) NON-CODING APPLICATION SOLUTION

(71) Applicant: VORBECK MATERIALS CORP., JESSUP, MD (US)

(72) Inventor: Ebennezer Eshun, Frisco, TX (US)

(73) Assignee: VORBECK MATERIALS CORP., JESSUP, MD (US)

(21) Appl. No.: 15/569,526

(22) PCT Filed: Apr. 22, 2016
(86) PCT No.: PCT/US16/28748

§ 371 Date: Oct. 26, 2017

Related U.S. Application Data
(60) Provisional application No. 62/151,164, filed on Apr. 22, 2015.

(51) Int. Cl. G06F 9/451; G06F 3/0488; G06F 3/0484; G06F 3/0486

(52) U.S. Cl. CPC G06F 9/451; G06F 3/0486; G06F 3/04842; G06F 3/04883

(57) ABSTRACT

Embodiments of the present invention relate to rendering unique sets of GUI elements on a generic mobile application. In an embodiment, a generic mobile application is transmitted to a mobile device for loading thereon. A first and second unique set of GUI elements associated with a first and second entity, respectively, is received. The first unique set of GUI elements or the second set of unique GUI elements is transmitted to the generic mobile application for rendering in response to a query for such information from a user of the generic mobile application. The first and second unique sets of GUI elements are generated by a first and a second administrator, respectively, using gesture based input. The first entity and the second entity are different. The first and second unique sets of GUI elements are different. The first and second administrators are different.

### CROSS-REFERENCE TO RELATED APPLICATIONS

This application is a 371 application of International Application No. PCT/US16/28748 filed Apr. 22, 2016, which claims priority to U.S. Provisional Application No. 62/151,164 filed Apr. 22, 2015, which are hereby incorporated herein by reference.

### BACKGROUND

### Technical Field

The present invention relates generally to mobile applications and specifically to non-coding mobile application solutions. Mobile applications (“apps”) are software designed to specifically run on a mobile devices, including but not limited to smartphones and tablet computers. Apps typically serve to provide users with similar services to those accessed on personal computers. Apps are generally small, individual software units with limited function. Some apps take PC-based applications and port them to a mobile device. However, this technique may not provide the desired level of functionality. An alternative approach typically involves specifically developing software for the mobile environment. App developers typically write code in one or more programming languages.

### BRIEF DESCRIPTION OF THE DRAWINGS

FIG. 1 depicts an environment, generally 100, in accordance with an embodiment of the present invention.

FIG. 2 depicts a data communication scheme, generally 200, that operates in the environment of FIG. 1, in accordance with an embodiment of the present invention.

FIG. 3 depicts the operational steps of an ecommerce application, generally 110, in accordance with an embodiment of the present invention.

FIG. 4 depicts the operational steps of the ecommerce application, in accordance with an embodiment of the present invention.

FIG. 5 depicts a block diagram of components of computing devices, in accordance with an embodiment of the present invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Mobile applications (“apps”) are software designed to specifically run on mobile devices. As used herein, “mobile devices” are portable wireless computing devices capable of running apps such as, but not limited, to smartphones, tablet computers, vehicular and wearable computers. Apps typically serve to provide users with similar services to those accessed on personal computers. Apps are generally small, individual software units with limited function. Some apps take PC-based applications and port them to mobile devices. However, this technique may not provide the desired level of functionality. An alternative approach typically involves specifically developing software for the mobile environment. App developers typically write software in one or more programming languages, which typically involves describing processes and procedures (i.e. the authoring of algorithms).

Where multiple mobile apps are desired, developers typically have to code at least a portion of each app from scratch. Even more, parties desiring to enter the mobile app space may be discouraged by the expense involved in hiring software developers and/or the time required to generate apps and/or update pre-existing apps.

Provided herein are solutions that allow users to at least partially generate apps using pointing device gesture coding techniques. The solutions allow users to customize a set of predefined GUI elements for subsequent rendering within a generic mobile app. The solution is described below in the context of embodiments as illustrated in the accompanying FIGS.

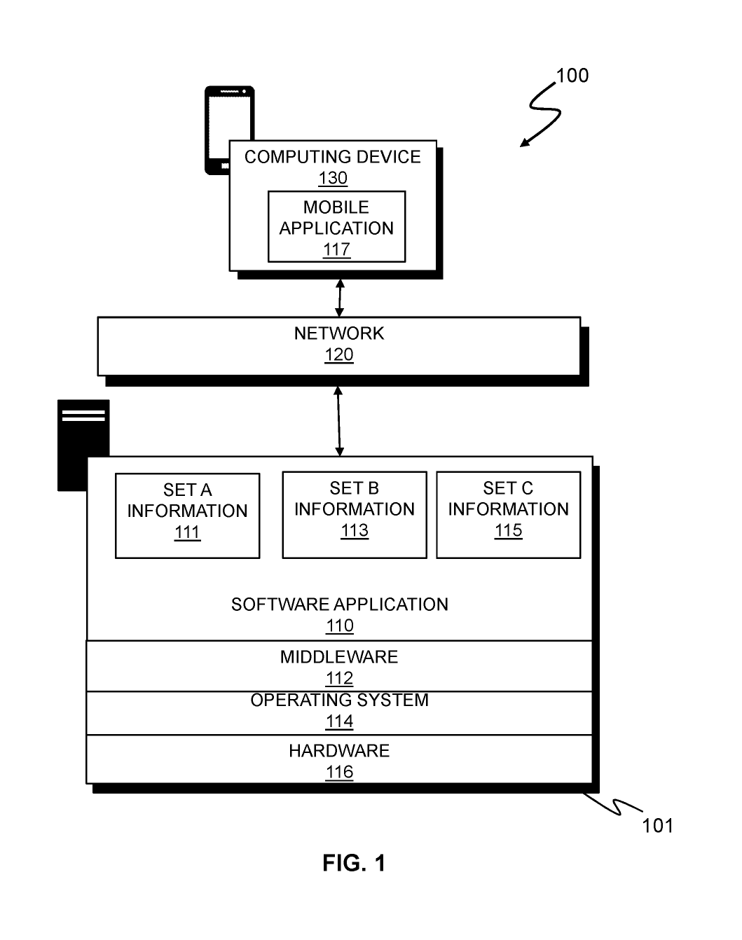

FIG. 1 depicts an environment, generally 100, in accordance with an embodiment of the present invention. Environment 100 includes computing device 130 that can communicate with computing device 101 via network 120. Network 120 can be, for example, a local area network (LAN), a wide area network (WAN) such as the Internet, or a combination of the two, and can include wired, wireless, and/or fiber optic connections. In general, network 120 can be any combination of connections and protocols that will support communications between any of the electronic components disclosed in the accompanying FIGS.

Computing device 130 is a mobile computing device that can run mobile apps, in accordance with an embodiment of the present invention. Computing device 130 may be utilized by end users to run mobile apps, such as mobile app 117. Computing device 130 included mobile app 117.

Software application 110 transmits, via network 120, mobile app 117 to computing device 130 for loading thereon. Mobile app 117 is a generic mobile app that renders GUI elements. In certain embodiments, mobile app 117 is a software platform for rendering GUI elements on mobile devices. Mobile app 117 can generate and transmit rendering requests to software application 110 for servicing. Rendering requests can consist of requests for GUI elements and any associated data, such as text, audio, and/or visual. In certain embodiments, mobile app 117 only renders GUI elements received from software application 110. In an embodiment, mobile app 117 is generic in the sense that it does not comprise renderable GUI elements associated with a set and/or entity (discussed below) and must receive such information from software application 110. In certain embodiments, mobile app 117 is generic in the sense that it provides the basic framework to render any set of GUI elements. In other embodiments, the basic framework consists of a platform that interfaces with the operating system and/or hardware of computing device 130. In additional embodiments, mobile app 117 is software that is strictly capable of rendering received GUI elements.

In an embodiment, mobile app 117 renders GUI elements received from a non-mobile app website in a manner optimized for viewing on mobile devices, for example computing device 130. For example, mobile app 117 may resize website originated GUI elements to a size optimized for viewing within mobile app 117. Mobile app 117 can comprise a list of entities received from software application 110. Each entity is associated with a unique “set” (defined below) of GUI elements. Information associated with each entity can be rendered on mobile app 117 via sets. The information may be political, academic, and/or commercial in nature. The information may be utilized to conduct commercial or non-commercial activities via mobile app 117. In general, entities can be any person, group of people, or organization that desires to convey information via mobile app 117, in accordance with an embodiment of the present invention. In certain embodiments, mobile app 117 communicates, via network 120, with software application 110 to obtain and/or update the entity list. Entity list updates may occur in real-time or at predetermined time intervals. End users can interface with mobile app 117 via voice commands, text input, image-based queries, and/or gesture inputs.

Computing device 101 can be a desktop computer, a wearable computer, a mobile computing device, a laptop computer, a tablet computer, a computer server, a vehicular-based computer, a home-integrated computer, a server, a computing cluster, a thin client, and/or any computing device that can execute code and communicate via network 120. In general, computing device 101 can be any computing device that can run software application 110, in accordance with an embodiment of the present invention.

Computing device 101 can include hardware layer 116, operating system 114, middleware 112, and software application 110. Although depicted as a single unit, computing device 101 can comprise a plurality of computing devices, wherein each is assigned one or more computing tasks, such as web server, application server, etc. Software application 110 is software that provides a mobile presence for one or more, in accordance with an embodiment of the present invention. Software application 110 converts user GUI element selections and associated positioning information, which is ascertained via pointing device gestures, in to computer code. Hence, software application 110 is software that reduces and/or eliminates the need to utilize traditional software coding techniques to generate mobile apps. Software code generated by software application 110 can be utilized by mobile app 117.

Software application 110 provides one or more GUI elements which may be selected for subsequent rendering on mobile app 117. As used herein, “administrators” are users of software application 110 that create and/or manage unique sets of GUI elements (“sets”) for entities. Sets can provide unique branding for entities. An administrator can be a person or group of persons authorized to create and/or manage a set for an entity. Sets can comprise one or more predefined GUI elements provided by software 110. Sets can comprise administrator-defined GUI elements that are only available to the defining administrator. Although FIG. 1 depicts sets A, B, and C, software application 110 can support any number of sets. Sets are not accessible by non-authorized administrators. At least a portion of the sets may be stored in data store 202, which may reduce the memory resource load that mobile app 117 may have on computing device 130. Sets may strictly be stored in data store 202 and/or computing device 130.

Software application 110 can service query requests received from mobile app 117. Mobile application 117 can, via software application 110, access for rendering sets included in set A information 111, set B information 113, and/or set C information. Set A information 111, set B information 113, and set C information 115 may be stored in data store 202. Each set can have its own data tables that are groups in to schema created specifically for that set.

Administrators can select GUI elements using pointing device gestures, including but not limited to drag-and-drop and/or cut-and-paste methodologies. In this manner, the pointing device gestures allow administrators to generate sets that reflect unique visual presentations when rendered on mobile application 117 without the need to draft code in a programming language. Software application 110 can also allow administrators to specify business rules, workflows and document flows, data structures, security policies, and/or dispensations. Entity specific information can only be accessed by authorized/designated administrators. A set's unique combination of GUI elements cannot be replicated in other sets. Sets are transmitted by application 110 to mobile application 117 for rendering thereon.

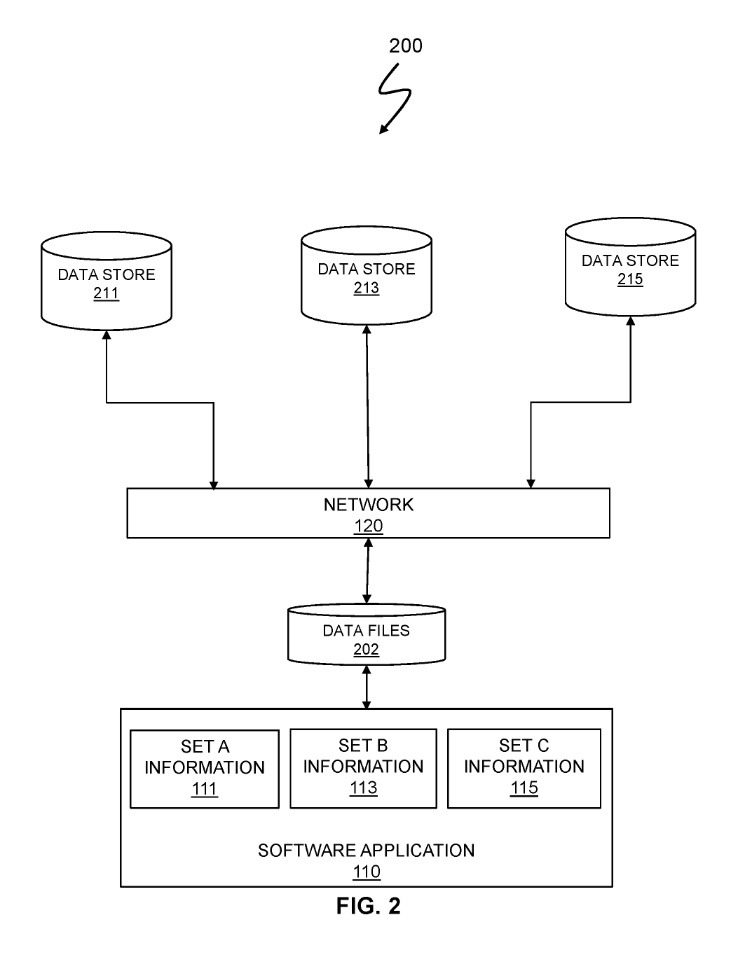

FIG. 2 depicts a data communication scheme, generally 200, that operates in environment 100 of FIG. 1, in accordance with an embodiment of the present invention. In certain embodiment, software application 110 can communication with external data stores associated with entities to provide additional functionality to mobile application 117. For example, external data bases may comprise proprietary information, inventory management information, and/or confidential information. Software application 110 can, via network 120, communicate with data store 202. Data store 202 is an information repository that can store information received from a plurality of external data stores, for example data stores 211, 213, and 215, which are associated with set A information 111, set B information 113, and set B information 115, respectively.

Information included in data stores 211, 213, and/or 215 can be generated using radio transponders. Information included in data stores 211, 213, and/or 215 can comprise data associated with dispensations, for example, commercial and/or non-commercial dispensations. Information included in data stores 211, 213, and/or 215 can comprise geolocational data. Information included in data stores 211, 213, and/or 215 can comprise data to facilitate pursual of dispensations. Information included in data stores 211, 213, and/or 215 can include data that facilitates the traversal of dispensations. Data store 202 can be included in computing device 101 or positioned external and in direct communication with network 120. Data store 202 can, via network 120, receive information, for example, in real-time, from data stores 211, 213, and/or 215.

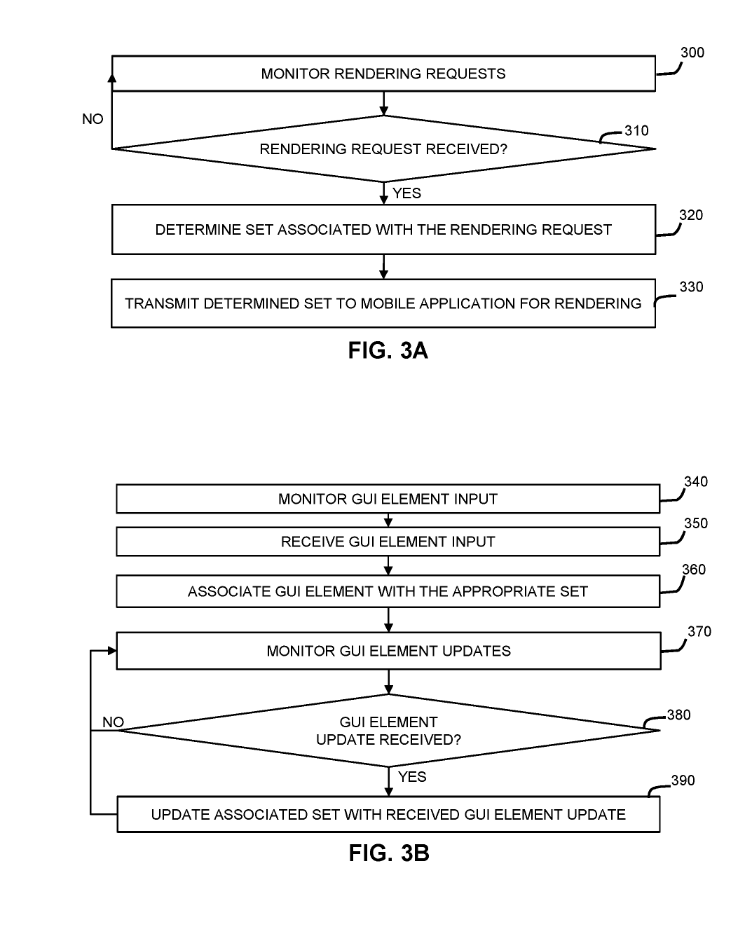

Information included in data store 202 can update in response to an update of information in data stores 211, 213, and/or 215. Such an update can occur at predetermined intervals and/or in real-time. FIG. 3A depicts the operational steps of software application 110, in accordance with an embodiment of the present invention. Specifically, FIG. 3A illustrates a method for servicing rendering requests received from mobile app 117. Software application 110 monitors rendering requests (step 300). If no rendering requests are received from mobile app 117 (“no” branch decisional 310), software application 110 returns to step 300. If a rendering quest is received from mobile app 117 (“yes” branch decisional 310), software application 110 determines the set associated with the rendering request (step 320).

For example, software application receives, via network 120, a rendering request transmitted by mobile app 117. The rendering request comprises an entityID. Software application 110 accesses the relationship tables included in data store 202 and determines which set is associated the entityID. Software application 110 transmits the determined set to mobile app 117 for rendering (step 330). For example, software application 110 accesses data store 202, retrieves the determined set, and transmits the determined set, via network 120, to mobile app 117 for rendering therein. The determined set may be transmitted in one or more data packets to mobile app 117 utilizing a communications protocol, including but not limited to, LTE, WIFI, 3G, 4G, or a wireless communications protocol.

FIG. 3B illustrates the operational steps of software application 110, in accordance with an embodiment of the present invention. Specifically, FIG. 3B illustrates a method for compiling a set. Software application 110 monitors GUI element input (step 340). For example, software application 110 presents to the user a designated template area and a designated rendered area. Software application 110 monitors the input of GUI element icons from the designated template area in to the designated rendered area of the software. Software application 110 receives GUI element input (step 350). Software application 110 associates the GUI element with the appropriate set (step 360).

For example, software application 110 registers that a user of software application 110 selects GUI elements A, B, and C via dragging and dropping the elements in to the designated rendered area in a desired position relative to each other. Software application 110 prompts the user to create a name for the new set, setID. In response to the aforementioned pointing device gestures and the naming input, software application 110 generates computer code that reflects the user desired GUI elements and their positioning relative to each other. The generated computer code is subsequently utilized by mobile app 117 in the rendering process.

Software application 110 generates a relationship table that conveys an association between GUI elements A, B, and C and setID. As a result, this particular relationship combination is unavailable for replication by another administrator. Software application 110 monitors GUI element updates (step 370). For example, once setID is created software application 110 monitors any updates to setID, which may include the inclusion and/or deletion of one or more GUI elements. If software application 110 does not receive any GUI element updates for the created set (“no” branch decisional 380), software application 110 returns to step 370.

If software application 110 receives a GUI element update for the created set (“yes” branch decisional 380), software application 110 updates the created set with the received GUI element update (step 390). For example, software application 110 detects that the user utilizes a drag-and-drop technique to remove element A from the rendered designated area, which causes software application 110 to remove the relationship between element A and setID reflected in the associated relationship table. Software application 110 generates new computer code reflecting updated setID.

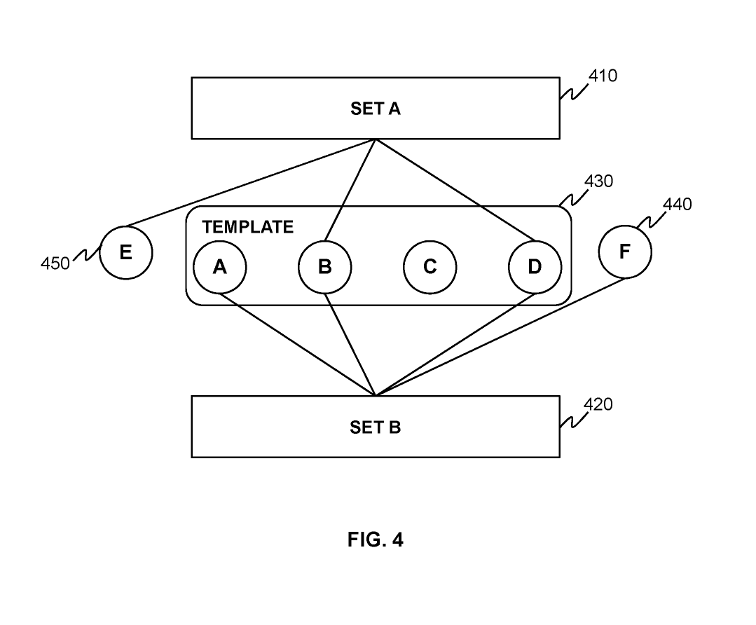

FIG. 4 depicts a GUI element relationship scheme, in accordance with an embodiment of the present invention. FIG. 4 comprises sets 410 and 420; template 430; and administrator defined GUI elements 450 and 440. Relationship tables are included in data store 202 that reflect relationships between sets and GUI elements. Relationship tables can be utilized by software application 110 to facilitate the retrieval and subsequent transmission of GUI elements. Template 430 and GUI elements 450 and 440 are typically included in data store 202. Here, template 430 is a compilation of predefined GUI elements available to administrators for set creation, for example, sets A and B. Template 430 comprises GUI elements A, B, C, and D. Although not shown, template 430 can comprise any number predefined GUI elements. Administrators can utilizes any combination of the GUI elements included in template 430 to generate a set of GUI elements. However, GUI elements sets must be unique and not utilized by another set.

Administrator defined GUI elements 450 is specifically associated with set 410. Administrator defined GUI element 440 is specifically associated with set 420. Administrator defined GUI elements are not available to other administrators without authorization from the authoring administrator. For example, the administrator of set 410, set A, using gesture-based input, utilizes software app 110 to generates a set comprising GUI elements B, D, from template 430 and GUI element 450, GUI element E. In response to mobile app 117 registering that entity A is selected, mobile app 117 transmits a request for sets associated with entity A, i.e. set A, to software application 110. In response to receiving the request, software application 110 relationship tables included in data store 202 and determines that GUI elements E, B, and D are included in set A and transmits the determined GUI elements to mobile app 117 for rendering therein. A similar process operates in relation to set B.

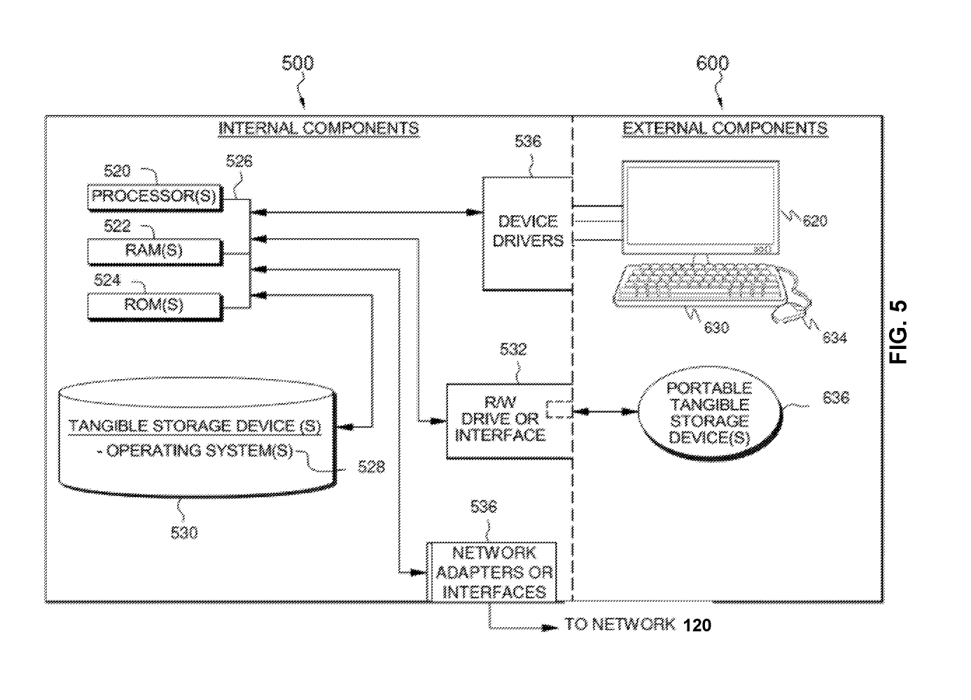

FIG. 5 depicts a block diagram of components of computing device 101 and/or computing device 130, in accordance with an embodiment of the present invention. Data processing system 500, 600 is representative of any electronic device capable of executing machine-readable program instructions. Data processing system 500, 600 may be representative of a smart phone, tablet computer, wearable computer, a computer system, personal digital assistant (PDA), or other electronic devices. Examples of computing systems, environments, and/or configurations that may represented by data processing system 500, 600 include, but are not limited to, personal computer systems, server computer systems, thin clients, thick clients, wearable computer, hand-held or laptop devices, multiprocessor systems, microprocessor-based systems, network PCs, minicomputer systems, and distributed cloud computing environments that include any of the above systems or devices.

Computing device 101 and/or computing device 130 can include respective sets of internal components 500 and external components 600 as illustrated in FIG. 5. Each of the sets of internal components 500 includes one or more processors 520, one or more computer-readable RAMs 522 and one or more computer-readable ROMs 524 on one or more buses 526, and one or more operating systems 528 and one or more computer-readable tangible storage devices 530. Operating system 114, middleware 112, ecommerce application 110, mobile application 117, and/or data store 202 can be stored on one or more of the respective computer-readable tangible storage devices 530 for execution by one or more of processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device, such as ROM 524, EPROM, flash memory or any other computer-readable tangible storage device that can store a computer program and digital information.

Internal components 500 also include a R/W drive or interface 532 to read from and write to one or more portable computer-readable tangible storage devices 636, such as a CD-ROM, DVD, memory stick, magnetic tape, magnetic disk, optical disk or semiconductor storage device. Operating system 114, middleware 112, data store 202, ecommerce application 110, and/or mobile application 117 can be stored on one or more of the respective portable computer-readable tangible storage devices 636, read via the respective R/W drive or interface 532 and loaded into the respective computer-readable tangible storage devices 530.

Each set of internal components 500 also includes network adapters or interfaces 536 such as a TCP/IP adapter cards, wireless Wi-Fi interface cards, or 3G or 4G wireless interface cards or other wired or wireless communication links. Operating system 114, middleware 112, data store 202, ecommerce application 110, and/or mobile application 117 can be downloaded to computing device 101, respectively, from an external computer via a network (for example, the Internet, a local area network or other, wide area network) and respective network adapters or interfaces 536. From the network adapters or interfaces 536, Operating system 114, middleware 112, data store 202, ecommerce application 110, and/or mobile application 110 can be loaded into the respective computer-readable tangible storage devices 530. The network may comprise copper wires, optical fibers, wireless transmission, routers, firewalls, switches, gateway computers and/or edge servers.

Each of the sets of external components 600 can include a computer display monitor 620, a keyboard (primary input device) 630, and a computer mouse (secondary input device) 634. External components 600 can also include touch screens, virtual keyboards, touch pads, pointing devices, gesture input devices, and other human interface devices. Internal components 500 also include device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages used for mobile applications. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

1. A method of rendering unique sets of GUI elements on a generic mobile application, the method comprising:
receiving, via a computing device, a unique set of GUI elements each associated with a particular entity of a plurality of entities, each unique set of GUI elements generated by a particular administrator;
storing, via the computing device, the received unique sets of GUI elements in a data store
receiving, via the computing device, a GUI element rendering request from the generic mobile application, the GUI element rendering request comprising a request for GUI elements associated with an entity of the plurality of entities;
identifying, via the computing device, a unique set of GUI elements of a plurality of unique sets of GUI elements associated with the entity; and
transmitting, via the computing device, the first unique set of GUI elements or the second set of unique GUI elements to the generic mobile application for rendering in response to a query for such information from a user of the generic mobile application.

2. The method of claim 1, wherein the unique set of GUI elements comprise a predefined GUI elements.

3. (canceled)

4. (canceled)

5. The method of claim 1, wherein each particular administrator is only allowed access to a unique set of GUI elements included in the plurality of unique sets of GUI elements that are associated with that particular administrator.

6. (canceled)

7. The method of claim 1, wherein the GUI element rendering query is generated using a text-based, a voice-based, gesture-based, and/or a picture-based input.

8. The method of claim 1, further comprising:
receiving, via the computing device, dispensation information from the first entity; and
transmitting, via the computing device, the received dispensation information to the generic mobile application for rendering.

9. The method of claim 1, further comprising receiving, via the computing device, dispensation information from the second entity and transmitting the received dispensation information to the generic mobile application for rendering.

10. A system to render unique sets of GUI elements on a generic mobile application, comprising:
a mobile device comprising a generic mobile application stored thereon, the generic mobile application configured to render GUI elements;
a data store configured to store unique sets of GUI elements
a control circuit communicatively coupled to the data store and the mobile device, the control circuit configured to:
receive a plurality of unique sets of GUI elements, each unique set of GUI elements associated with a particular entity, each unique set of GUI elements generated by a particular administrator;
store the received plurality of unique sets of GUI elements in the data store;
receive a GUI element rendering request from the generic mobile application, the GUI element rendering request comprising a request for GUI elements associated with an entity:
identify a unique set of GUI elements of the plurality of unique sets of GUI elements associated with the entity.

11. The system of claim 10, wherein a unique set of GUI elements of the plurality of unique sets of GUI elements comprises a predefined GUI elements.

12. (canceled)

13. (canceled)

14. The system of claim 10, wherein each particular administrator is only allowed access to a unique set of GUI elements included in the plurality of unique sets of GUI elements that are associated with that particular administrator.

15. (canceled)

16. The system of claim 10, wherein the query is generated using a text-based, a voice-based, gesture-based, and/or a picture-based input.

17. The system of claim 10, further comprising:
receiving, via the processor, dispensation information from the entity; and
transmitting, via the processor, the received dispensation information to the generic mobile application for rendering.

18. The system of claim 10, wherein the control circuit is further configured to:
receive, via the control circuit, dispensation information from the entity; and
transmit, via the control circuit, the received dispensation information to the generic mobile application for rendering.
